(19) United States
(12) Patent Application Publication
(10) Pub. No.: US 2017/0347005 A1
(43) Pub. Date: Nov. 30, 2017

(54) IMAGE PICKUP APPARATUS, IMAGE PICKUP METHOD, AND PROGRAM

(71) Applicant: CANON KABUSHIKI KAISHA, TOKYO (JP)

(72) Inventor: Naoto Kimura, Yokohama-shi (JP)

(21) Appl. No.: 15/599,210

(22) Filed: May 18, 2017

(30) Foreign Application Priority Data
May 27, 2016 (JP) 2016-106642

(51) Int. Cl. H04N 5/235; G06T 3/00; H04N 5/232; H04N 5/265

(52) U.S. Cl. CPC H04N 5/2352; H04N 5/265; G06T 3/0068; H04N 5/23238; H04N 5/2351

(57) ABSTRACT

An image pickup apparatus includes an image pickup device and a control circuit. While the image pickup device picks up a plurality of images of a first image group, the image pickup device picks up a plurality of images of a second image group, which differs from the first image group, plural times. In picking up the images of the first image group and the second image group, the control circuit sets a changeable image pickup condition. A range of the changeable image pickup condition where the image pickup device picks up the images of the first image group is narrower than a range of the changeable image pickup condition where the pickup device picks up the images of the second image group. The combining processing is performed, using the plurality of images of the first image group and not using the plurality of images of the second image group.

### BACKGROUND OF THE INVENTION

### Field of the Invention

The present disclosure relates to at least one embodiment of an image pickup apparatus, a method for controlling the image pickup apparatus, and a program, and more specifically relates to an image pickup operation for generating a panoramic image.

### Description of the Related Art

Known is a technique in which an image pickup apparatus picks up a plurality of images while a user swings the image pickup apparatus once, and in which a panoramic image is generated with use of these images.

In generating the panoramic image, in a case in which there is a difference in setting of an image pickup condition including an aperture state, exposure time, and the like for image pickup between adjacent images, a seam will stand out in the generated image. For this reason, it is preferable to fix the image pickup condition when the plurality of images for use in generating the panoramic image are picked up.

Under such circumstances, Japanese Patent Laid-Open No. 2013-162188 discloses a configuration in which, in swing-type panoramic image pickup, pre-pickup is performed before regular pickup, in which a plurality of images for use in generating a panoramic image are picked up, and the regular pickup is performed with use of one image pickup condition determined based on the images generated in the pre-pickup.

However, since the panoramic image has a wide field angle, subjects having different image pickup conditions appropriate to the respective subjects (for example, a subject in a backlit state and a subject in a forward-lit state) will highly-possibly exist together. Thus, even in a case of using a method described in Japanese Patent Laid-Open No. 2013-162188, when a subject having luminance significantly different from luminance appropriate for the entire panoramic image exists, the subject will be in an underexposed or overexposed state.

### SUMMARY OF THE INVENTION

At least one object of the present disclosure is to provide at least one embodiment of an image pickup apparatus enabling a panoramic image hardly giving rise to unnaturalness in a seam to be generated and enabling underexposure and overexposure to be reduced.

At least one embodiment of an image pickup apparatus according to the present disclosure includes an image pickup unit configured to pick up an image, a setting unit configured to set an image pickup condition when the image pickup unit picks up the image, and a combining unit configured to perform combining processing for combining a plurality of images picked up by the image pickup unit. While the image pickup unit picks up a plurality of images categorized as a first image group, the image pickup unit picks up a plurality of images categorized as a second image group, which is different from the first image group, plural times. The setting unit sets a common image pickup condition where the image pickup unit picks up the images of the first image group. The setting unit sets a different image pickup condition for each of the images where the image pickup unit picks up the images of the second image group. The combining unit performs the combining processing, using at least the plurality of images of the first image group.

According to other aspects of the present disclosure, one or more additional image pickup apparatuses, one or more image pickup methods, one or more programs and one or more storage mediums for use therewith are discussed herein. Further features of the present disclosure will become apparent from the following description of exemplary embodiments (with reference to the attached drawings).

### BRIEF DESCRIPTION OF THE DRAWINGS

FIG. 1 is a block diagram illustrating a functional configuration of a digital camera according to an embodiment of the present disclosure.

FIG. 2 is a flowchart illustrating image pickup processing for a panoramic image in the digital camera according to a first embodiment.

FIGS. 3A to 3E illustrate a method for calculating an exposure value according to an embodiment of the present disclosure.

FIGS. 4A and 4B describe vector detection according to an embodiment of the present disclosure.

FIGS. 5A and 5B describe alignment according to an embodiment of the present disclosure.

FIG. 6 describes generation of a combined image according to an embodiment of the present disclosure.

FIG. 7 describes image pickup processing for a panoramic image in a digital camera according to a second embodiment of the present disclosure.

FIG. 8 illustrates a function for use in adjusting an exposure value at the time of picking up a still image according to the second embodiment of the present disclosure.

### DESCRIPTION OF THE EMBODIMENTS

Hereinbelow, preferred embodiments of the present disclosure will be described with reference to the drawings. Although a digital camera is raised as an example of an image pickup apparatus in the following description, at least one embodiment of the present disclosure is not limited to a configuration described below.

### First Embodiment

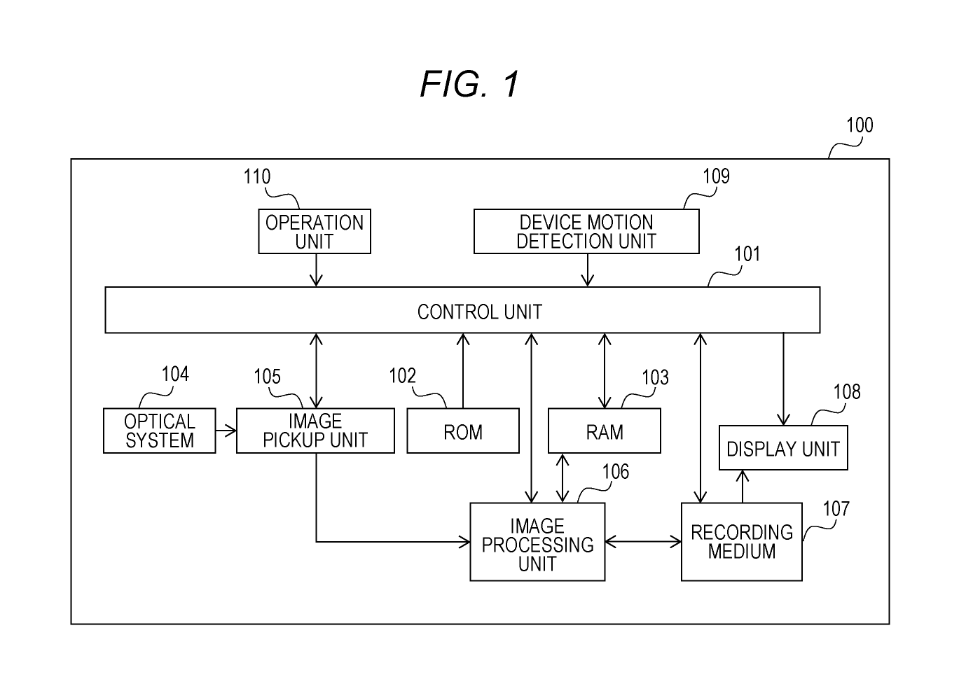

FIG. 1 is a block diagram illustrating a functional configuration of a digital camera 100 according to an embodiment of the present disclosure. A control unit 101 is a signal processor such as a CPU or an MPU. The control unit 101 reads out an operation program of each of blocks included in the digital camera 100 from a ROM 102 serving as a recording medium and loads and executes the program into a RAM 103 to control an operation of each of the blocks included in the digital camera 100. The ROM 102 is a rewritable non-volatile memory and stores parameters and the like required for the operation of each of the blocks as well as the operation program of each of the blocks included in the digital camera 100. The control unit 101 performs control required for an operation of the digital camera 100 while the control unit 101 reads out the operation program, the parameters required for the control, and the like from the ROM 102. For example, as described below, the control unit 101 issues a command for start or end of image pickup to an image pickup unit 105 and issues a command for image processing to an image processing unit 106. The RAM 103 is a rewritable non-volatile memory and is used as a temporary memory region for data output in the operation of each of the blocks included in the digital camera 100.

The optical system 104 forms a subject image on the image pickup unit 105. The image pickup unit 105 is an image pickup device such as a CCD and a CMOS sensor, photoelectrically converts an optical image formed on the image pickup device by the optical system 104, and outputs an obtained image signal to the image processing unit 106.

The image processing unit 106 applies various kinds of image processing such as white balance adjustment, color interpolation, and filtering to an image output from the image pickup unit 105 or image data stored in the RAM 103. This image processing unit 106 is an integrated circuit (ASIC) into which circuits performing specific processing are integrated. Alternatively, the control unit 101 may partially or entirely fulfill the function of the image processing unit 106 by performing processing based on a program read out from the ROM 102. In a case in which the control unit 101 entirely fulfills the function of the image processing unit 106, the image processing unit 106 does not need to be included as hardware.

A recording medium 107 is a memory card, a built-in memory, or the like and records an image processed in the image processing unit. The recording medium 107 also outputs an image to be processed to the image processing unit 106 based on a command from the control unit 101.

A display unit 108 is a display device such as a liquid crystal display (LCD) and an organic EL display. The display unit 108 displays various kinds of information. For example, the display unit 108 acquires via the control unit 101 a subject image obtained in the image pickup unit 105 or displays an image recorded in the recording medium 107.

A device motion detection unit 109 is a gyroscopic sensor, is a device for detecting motion of the digital camera 100, and detects motion of the digital camera 100 in a yaw direction and in a pitch direction based on angular change, that is, angular velocity, of the digital camera 100 per unit time.

An operation unit 110 is a button, a switch, or a touch panel. A command from a user reaches the control unit 101 through the operation unit 110.

The user picks up images while moving the digital camera described above to enable an image group including the plurality of images to be obtained.

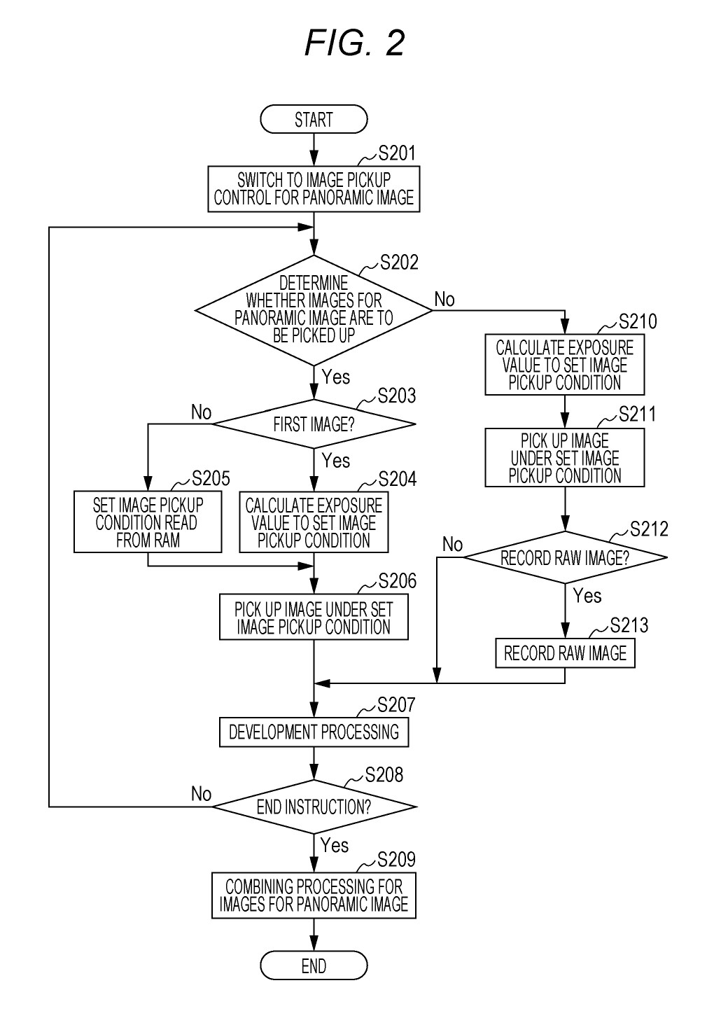

FIG. 2 is a flowchart illustrating image pickup processing for a panoramic image in the digital camera 100 according to the first embodiment. The present embodiment is characterized by preforming processing of picking up an image for a still image while picking up a plurality of images for a panoramic image. It is to be noted that image pickup for normal live view has been performed since before image pickup for a panoramic image is started. The flow in FIG. 2 starts when the control unit 101 detects a predetermined operation performed by the user in the operation unit 110 such as pressing down a shutter button included in the operation unit 110. Alternatively, the flow in FIG. 2 may start when it has been determined that a preset condition is satisfied such as elapse of a predetermined period of time since switching to a mode for panoramic image pickup.

In step S201, the control unit 101 sets control for image pickup to control for picking up a plurality of images for a panoramic image.

In step S202, the control unit 101 determines whether an image that is going to be picked up is an image for generation of a panoramic image or an image for a still image in accordance with a preset determination condition.

For example, in a case in which the digital camera moves by a preset distance d1 from a position at which pickup of an image for generation of a panoramic image is started or a position at which a still image has been picked up previous time, an image that is going to be picked up by the image pickup unit 105 is determined as a still image. All images to be picked up before the moving distance of the digital camera reaches d1 are determined as images for a panoramic image. Thus, the number of images for a panoramic image to be picked up is larger than the number of still images to be picked up. In this manner, by picking up images for a panoramic image at preset intervals, still image pickup is performed plural times while a plurality of images for generation of a panoramic image are being picked up. By setting this distance d1 to be equal to or slightly shorter than a field angle per image pickup, an area in which the respective still images overlap can be reduced. In a case in which the distance d1 is set to a higher value than the field angle per image pickup, a subject that is not picked up in a still image will exist. Attention must be paid to this point.

Meanwhile, as for an image for a panoramic image, a condition in which an image that is going to be picked up by the image pickup unit 105 each time the moving distance of the camera does not reach d1 but reaches d2, which is shorter than d1, is determined as an image for a panoramic image may be set. Also, to reduce an influence of distortion on both sides of an image, processing of generating a panoramic image may be performed after only a strip part at the center of each image for use in the generation processing is extracted. In this case, to minimize the number of images for use in generating a panoramic image, it is preferable to set d2 in accordance with the width of the strip and to pick up an image for a panoramic image each time the moving distance reaches d2.

Also, as other examples of the image pickup pattern, instead of the distances d1 and d2, rotating angles a1 and a2, pickup counts n1 and n2, or time periods t1 and t2 may be set. These determination conditions may be set in advance or may be selected by the user. With such a configuration, image pickup can be performed plural times while an image for generation of a panoramic image and an image for a still image are alternately picked up.

In a case in which it is determined in step S202 that an image for generation of a panoramic image is going to be picked up, the procedure moves to step S203. In a case in which it is determined in step S202 that not an image for generation of a panoramic image but an image for a still image is going to be picked up, the procedure moves to step S210.

In step S203, the control unit 101 determines whether or not an image to be picked up in the following step S206 is a first-picked image out of a plurality of images for use in generation of the panoramic image. In a case in which the control unit 101 has determined that the image is a first image, the procedure moves to step S204. In step S204, the control unit 101 calculates an exposure value with use of a below-mentioned calculation method, and based on the calculated exposure value, an image pickup condition including an aperture value, shutter speed (this is synonymous with exposure time and includes not only mechanical shutter speed but also image pickup time by means of accumulation time control), an ISO value (sensitivity value), and the like is set. The image pickup condition set by the control unit 101 is temporarily stored in the RAM 103.

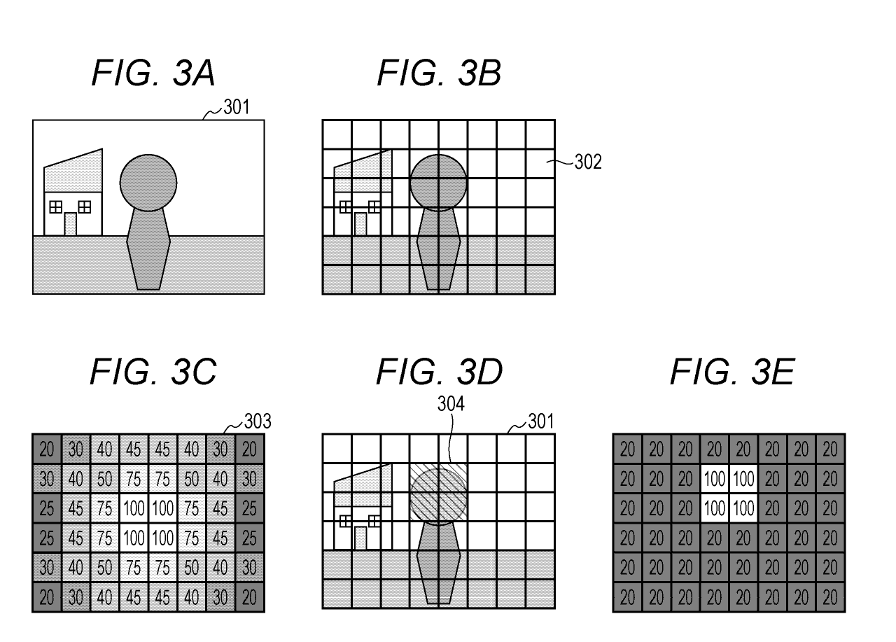

Next, the method for calculating the exposure value in step S204 will be described with reference to FIGS. 3A to 3E.

For an image 301 illustrated in FIG. 3A output in the image processing unit before the first image for use in generation of the panoramic image is picked up, brightness of the frame is evaluated, and the exposure value is calculated. First, as illustrated in FIG. 3B, the region of the image 301 is divided into a plurality of blocks. For each block such as a block 302, an average value of luminance signals is calculated. As a method for calculating a luminance signal of each pixel included in each block, a method of extracting R, G, and B signal values and calculating a luminance signal Bcy of each pixel from the R, G, and B signal values with use of a conversion equation shown in (Formula 1) is generally used.

Bcy=0.299R+0.587G+0.114B (Formula 1)

When the total number of blocks is n, an average value of the luminance signals Bcy obtained in each block is By, and a weighting coefficient for each block is w, an evaluation value Ey for brightness of the frame can be calculated by means of (Formula 2).

$$\begin{matrix}[ Equation 1 ] & \\ Ey = \frac{{\sum }_{i = 1}^{n} {w}_{i} {By}_{i}}{{\sum }_{i = 1}^{n} {w}_{i}} & ( Formula 2 )\end{matrix}$$

The weighting coefficient for each block depends on a position of the block in the frame, and an example thereof is illustrated in FIG. 3C. In a coefficient distribution 303 illustrated in FIG. 3C, the weighting coefficients for blocks are higher as the blocks are arranged further in a direction toward the center of the frame. Also, a region 304 that is desired to be emphasized may be specified as illustrated in FIG. 3D to produce a coefficient distribution in which the blocks corresponding to the region 304 are provided with higher weighting coefficients as illustrated in FIG. 3E.

With use of the evaluation value Ey for brightness of the frame calculated by means of (Formula 2), an exposure value EV can be calculated by means of (Formula 3) shown below. In the formula, ref_Y is a target luminance value for use in calculation of the exposure value, and EV0 is an exposure value of the image 301 set currently.

$$\begin{matrix}[ Equation 2 ] & \\ EV = EV 0 + {log}_{2} ( \frac{Ey}{ref\_Y} ) & ( Formula 3 )\end{matrix}$$

In step S203, in a case in which the control unit 101 has determined that the image to be picked up in step S206 for use in generation of the panoramic image is not a first image, the procedure moves to step S205. In step S205, the control unit 101 reads out an image pickup condition for a first image from the RAM 103 and sets an image pickup condition for the image to be picked up in step S206 for use in generation of the panoramic image so that the image pickup condition for the image to be picked up in step S206 may be approximately equal to that for the first image. In this manner, the image pickup unit 105 picks up a plurality of images for generation of the panoramic image under setting of the common image pickup condition. It is to be understood in the present embodiment that the common image pickup condition is not limited to a completely equal condition. When the panoramic image is generated in step S209 described below with use of the images picked up under such a similar image pickup condition, images on both sides of a seam have few differences in brightness, a color tone, and the like, and a more natural panoramic image can be generated.

In step S206, the image pickup unit 105 picks up an image under the image pickup condition set in step S204 or step S205.

In a case in which the control unit 101 has determined in step S202 that an image for a still image is going to be picked up, the procedure moves to step S210.

In step S210, the control unit 101 calculates an exposure value based on an image picked up most recently for generation of a panoramic image and sets an image pickup condition based on the calculated exposure value. That is, unlike step S205, in which the common image pickup condition read from the RAM 103 is set, an appropriate image pickup condition is calculated and set each time.

In a case in which, among the image pickup condition items, the aperture value is significantly changed from that for picking up a panoramic image, time required for driving of the aperture will increase since the aperture needs to be changed for a still image and be turned back for the panoramic image after picking up the still image. Thus, an upper limit for the driving amount of the aperture may be set, and exposure time (image pickup time) and ISO may cover the aperture.

Also, in a case in which exposure time for a still image is too long, an image pickup interval for picking up images for a panoramic image will be long, and lack of the field angle may occur. Thus, an upper limit for the exposure time may be set.

Subsequently, in step S211, the image pickup unit 105 picks up an image under the image pickup condition set in step S210.

In step S212, the control unit 101 determines whether a RAW image is to be recorded. In a case in which recording of a RAW image is set, the procedure moves to step S213, a RAW image is recorded, and development processing is then performed in step S207. In a case in which recording of a RAW image is not set, the procedure moves directly to step S207. Since the RAW image is data that is subject to no development processing and stored as it is without changing arrangement of color components of digital data of an image picked up by the image pickup unit 105, the RAW image cannot be displayed directly on the display unit 108. However, since the RAW image is subject to no compression processing, the user can select an arbitrary method to perform development of the RAW image afterward. It is to be noted that the RAW image is not limited to an uncompressed image, and the RAW image may be subject to lossless compression or weak compression processing. The RAW image according to the present embodiment includes such images.

In step S207, the image processing unit 106 performs development processing to the image picked up in step S206 or S211. In the development processing, the image processing unit 106 performs known processing such as noise reduction processing, edge emphasis processing, and gamma processing to the image and generates a file having a format such as JPEG.

In step S208, the control unit 101 determines whether or not an end instruction is provided by detecting a predetermined operation performed by the user in the operation unit 110 such as stopping pressing down the shutter button included in the operation unit 110. Alternatively, the control unit 101 may determine whether or not an end instruction is provided by detecting that the number of images picked up for generation of a panoramic image exceeds a predetermined value or detecting that a change of the field angle of the picked image exceeds a predetermined angle. In a case in which the control unit 101 has determined in step S208 that an end instruction is provided, image pickup for generation of a panoramic image is ended, the procedure moves to step S209, and combining processing is performed. In a case in which the control unit 101 has determined in step S208 that no end instruction is provided, the procedure returns to step S202.

In step S209, combining processing is performed for the images picked up by the image pickup unit 105 in step S206 and undergone the development processing in step S207. Meanwhile, the image for the still image picked up in step S211 is not used for the combining processing in step S209 and is stored in the recording medium 107 separately from the panoramic image.

Generally, in the combining processing, features between images are extracted, motion vectors are detected, alignment is performed, and parts of the respective images are cut out and combined. Details thereof will be described below.

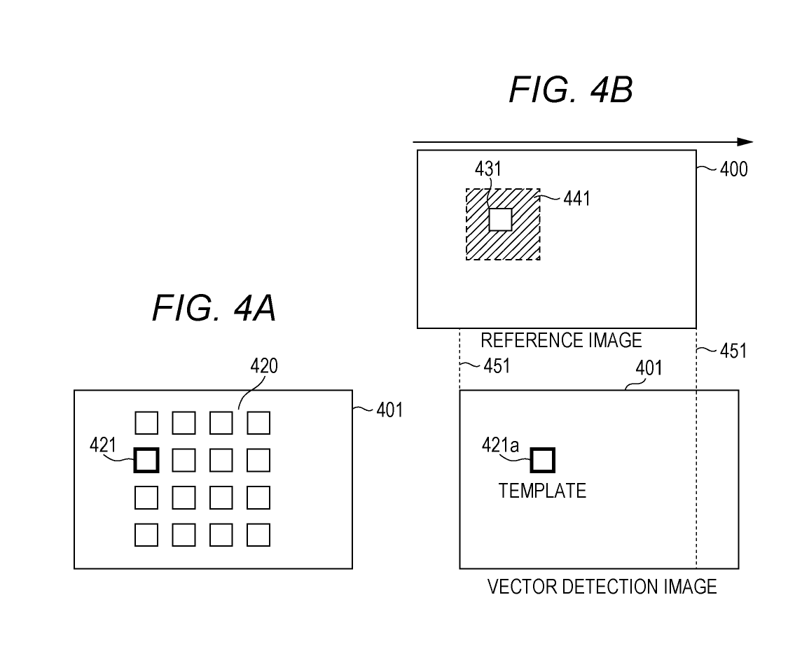

FIGS. 4A and 4B illustrate two images picked up serially in chronological order. In a vector detection image (a temporarily later image of the two images) in FIG. 4A, a vector detection region group 420 is illustrated. Images included in respective vector detection regions 421 included in the vector detection region group 420 are used as template images at the time of vector detection, and one vector is derived from each template image.

The image processing unit 106 detects a motion vector between images. As a method for detecting the motion vector, a known method may be employed. An example thereof is a template matching method. In this method, the displacement amounts between images are compared by setting a template in a predetermined range, and the displacement amount at a position having the lowest comparison value (position at which inter-image correlation is the highest) is detected as a vector.

The template matching will be described with reference to FIGS. 4A and 4B. In the template matching, a template 421a is determined from the vector detection region group of the vector detection image to detect the moving amount. In the present embodiment, since the vector detection region group is set only in a partial region of the image, calculation load required for detection of the motion vector can be reduced further than in a case of detecting the motion vector from the entire image. This template 421a may be set only in the vector detection region corresponding to a small region whose contrast is determined to be a preset reference value or higher. An image corresponding region of a reference image 400 and a vector detection image 401 (range in which the same subjects are picked up) is shown between dashed lines 451 and 452. A corresponding position of a region of the template 421a determined from the vector detection image and a region on the reference image corresponding to the template 421a is set as a vector search start position. A region on the reference image having the same coordinates as coordinates of the template 421a on the vector detection image is assumed as a region 431. In a vector search range 441 set to be larger than the region 431, centering on the region 431, comparison calculation with the template 421a is performed, and displacement between a position with the highest correlation and the vector search start position is detected as a vector. This operation is performed for all of the set template images, and as many motion vectors as the number of the template images are detected.

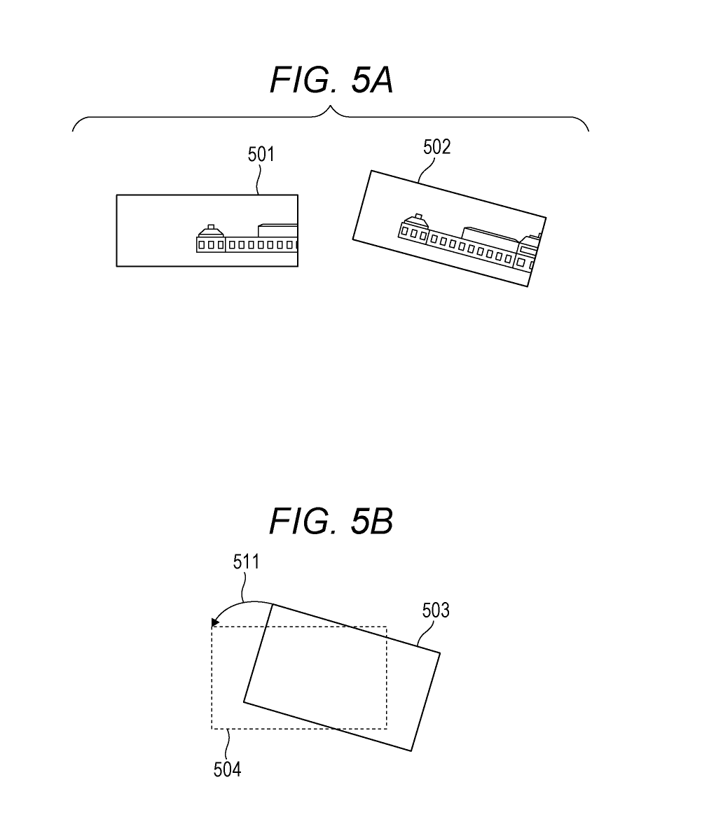

Subsequently, with use of the detected motion vectors, alignment processing is performed. The alignment processing will be described with reference to FIGS. 5A and 5B.

In the alignment processing, an alignment coefficient for correcting the deformation amount between the images is calculated. At the time of image pickup, not only a translational component but also hand shake occur, and a rotational component and a tilt component thus occur, which causes an image influenced by the rotation and the tilt, such as an image 502, to be picked up. In such a case, as a coefficient for correcting the translational component, the rotational component, and the tilt component by means of geometric deformation, a conversion coefficient is calculated. The conversion coefficient for the geometric deformation is referred to as an alignment coefficient. For example, a frame 503 schematically illustrates the image 502 before the geometric deformation while a frame 504 schematically illustrates the image 502 after the geometric deformation. An alignment coefficient A corresponding to an arrow 511 is generally expressed in (Formula 4). When a coordinate value of the image is I (x-coordinate, y-coordinate), calculation of (Formula 5) brings about the geometric deformation from the frame 503 to the frame 504.

$$\begin{matrix}[ Equation 3 ] & \\ A = ( \begin{matrix}a & b & c \\ d & e & f \\ g & h & i\end{matrix} ) & ( Formula 4 ) \\ [ Equation 4 ] & \\ {I}^{′} = ( \begin{matrix}{x}^{′} \\ {y}^{′} \\ 1\end{matrix} ) = AI = ( \begin{matrix}a & b & c \\ d & e & f \\ g & h & i\end{matrix} ) ( \begin{matrix}x \\ y \\ 1\end{matrix} ) & ( Formula 5 )\end{matrix}$$

To calculate the alignment coefficient, two images consisting of an image as a reference for alignment and an image targeted for correction are set. The template matching is then performed to calculate vectors.

Subsequently, with use of the calculated vector group, the geometric conversion coefficient is derived. For example, as in (Formula 5), the conversion coefficient A, to be derived when a difference ε between a coordinate value I′ derived by multiplying the coordinate value I of a feature point on the alignment target image by the predetermined conversion coefficient A and a coordinate value of a feature point on the reference image is the lowest, is derived.

The conversion coefficient A is derived with use of a known optimization method such as the Newton method and the Gauss-Newton method. The derived conversion coefficient A is employed as the alignment coefficient.

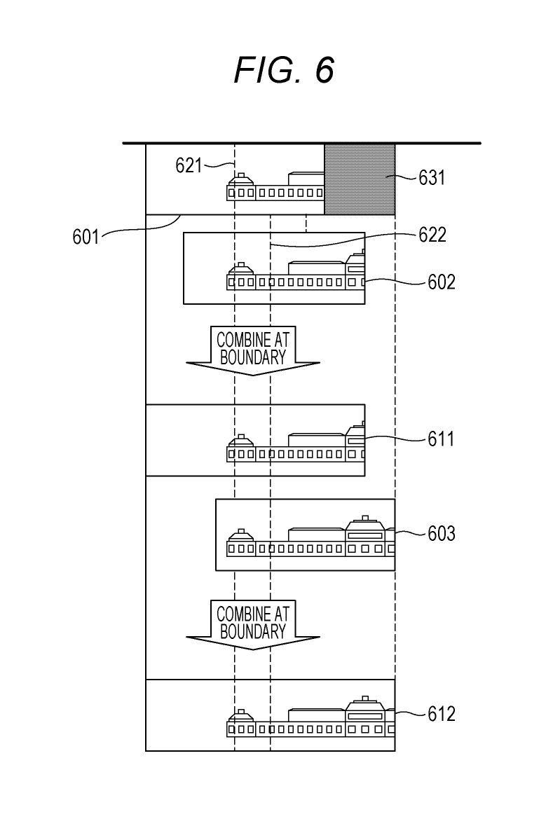

Finally, the images subject to the aforementioned alignment processing are subject to combining processing around inter-image boundaries. The image combining processing will be described with reference to FIG. 6. Images 601 to 603 in FIG. 6 are images subject to the alignment processing. Combining processing is sequentially performed at boundaries of the three images.

In a case of combining the image 601 with the image 602, the combining processing is performed, using a line 621 at a center position in the horizontal direction of the image 601 as a boundary. Specifically, processing of outputting the image 601 in a left region of the line 621, outputting the image 602 in a right region of the line 621, and mixing pixel information of the two images on the line 621 to make the seam appear natural, is performed. Alternatively, a value derived by mixing the pixel information of the image 601 and the image 602 50% each is output on the line, and as a position is further away from the line, a value derived by mixing the pixel information by further increasing the ratio of the image 601 is output on the left side of the line while a value derived by mixing the pixel information by further increasing the ratio of the image 602 is output on the right side of the line. A combined image is a combined image 611.

Subsequently, the combined image 611 and the image 603 are combined. At this time, the combining processing is performed, using a line 622 at a center position in the horizontal direction of the previous image 602 as a boundary. A combined image is a combined image 612. In this manner, alignment and image combining are sequentially performed. Due to the combining processing of the image 601 with the image 602 and the image 603, the field angle can be extended as much as a region 631 in comparison with the image 601.

In this manner, according to the first embodiment, in the swing-type panoramic image pickup, one-time swing movement enables both the panoramic image and the still image to be picked up under respective appropriate image pickup conditions.

Conventionally, in a case in which a subject that has undergone inappropriate exposure control to a panoramic image condition is to be cut out and displayed, the subject that has undergone inappropriate exposure control is enlarged and displayed. Conversely, according to the present disclosure, since the subject is enlarged and displayed by cutting out the corresponding region from a still image, such a partial image can be enlarged and displayed in a state of undergoing appropriate exposure control.

Also, when a still image is recorded as a RAW image, the RAW image can be subject to arbitrary development processing afterward. Thus, development processing in which parameters are set so that a subject specified by the user may have favorable luminance can be performed. Also, in a case in which the subject specified by the user exists at a boundary of a plurality of images, development processing can be performed by controlling a distortion compensation parameter so that distortion shapes may correspond at the boundary.

### Second Embodiment

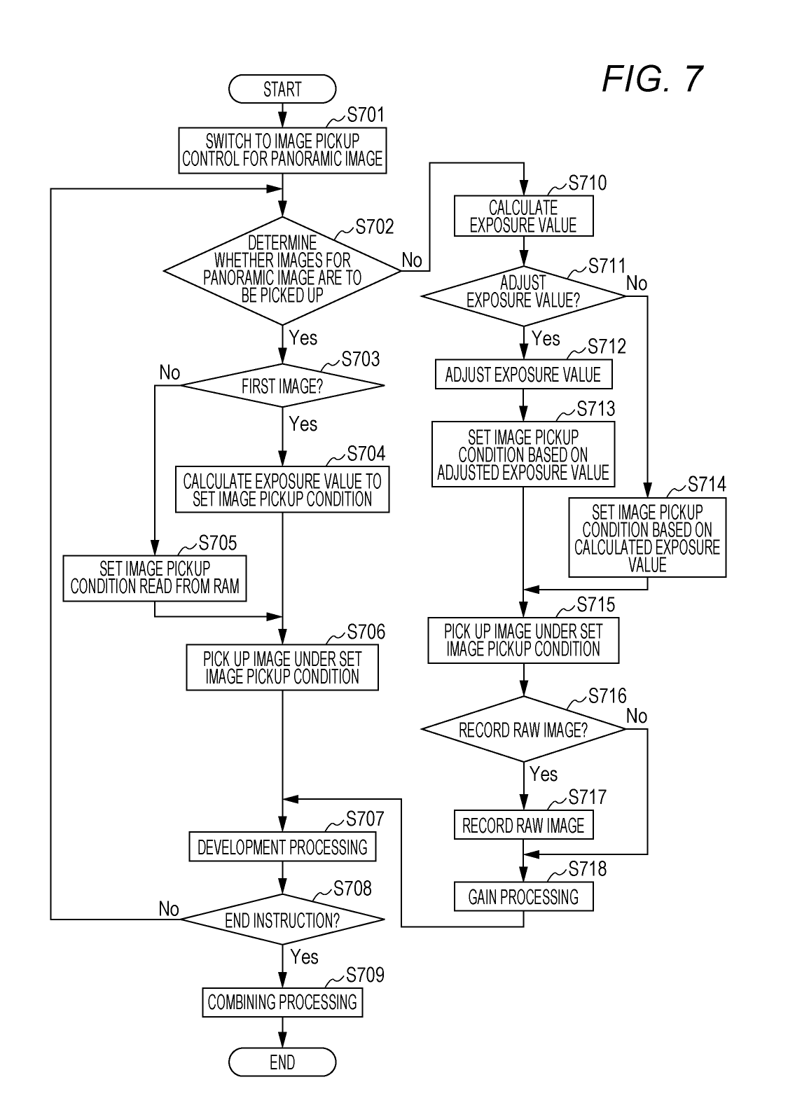

A second embodiment differs from the first embodiment in that a still image is also used for generation of a panoramic image. With reference to FIG. 7, the second embodiment will be described mainly about the differences from the first embodiment. Steps S702 to S708 are similar to steps S202 to S208 in the first embodiment.

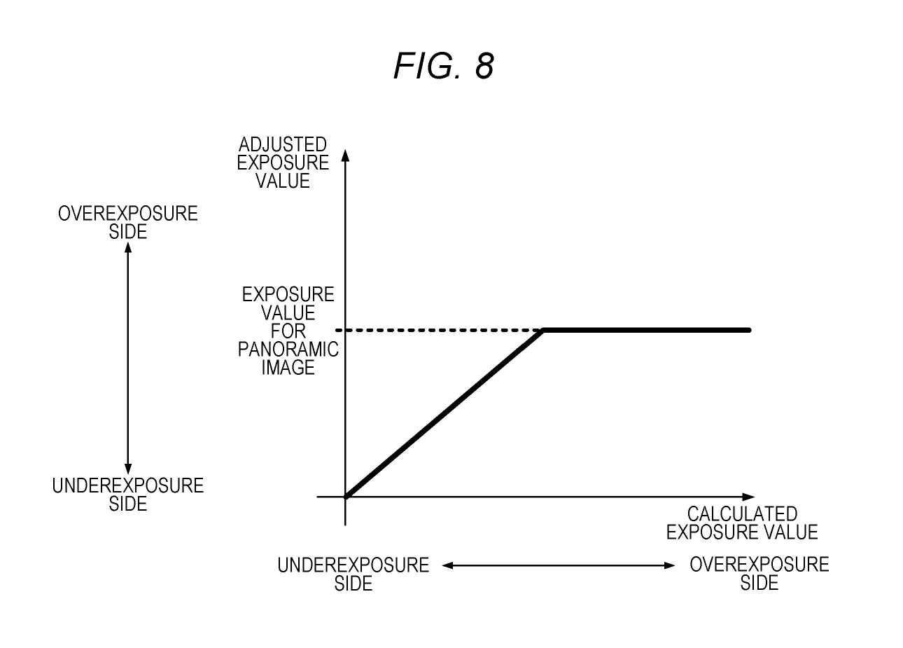

In a case in which the control unit 101 has determined in step S702 that an image that is going to be picked up is not an image for generation of a panoramic image but a still image, the procedure moves to step S710. In step S710, the control unit 101 calculates an exposure value in a similar manner to that in step S210 in the first embodiment. In step S711, the control unit 101 determines whether the exposure value is to be adjusted in the below-mentioned method. In a case in which the control unit 101 has determined that the exposure value is to be adjusted, the exposure value is adjusted in step S712 in accordance with the function illustrated in FIG. 8 and sets an image pickup condition including an aperture value, shutter speed (exposure time, image pickup time), an ISO value, and the like in step S713 based on the adjusted exposure value. In a case in which the control unit 101 has determined that the exposure value is not to be adjusted, the procedure moves to step S714, and the control unit 101 sets an image pickup condition including an aperture value, shutter speed, an ISO value, and the like based on the exposure value calculated in step S710.

In step S715, the image pickup unit 105 picks up an image under the image pickup condition set in step S713 or S714.

In step S716, the control unit 101 determines whether a RAW image is to be recorded. In a case in which recording of a RAW image is set, the procedure moves to step S717, a RAW image is recorded, and the procedure moves to step S718. In a case in which recording of a RAW image is not set, the procedure moves directly to step S718.

In step S718, the image processing unit 106 performs gain (sensitivity value) processing for adjusting luminance of the still image to luminance of the image picked up for generation of the panoramic image. In the present embodiment, since the still image is also used for generation of the panoramic image, the image picked up for generation of the panoramic image and the image picked up as the still image need to have corresponding luminance values. Specifically, the image processing unit 106 performs processing of applying to the still image gain set in accordance with the difference between the image pickup condition for picking up the image for generation of the panoramic image and the image pickup condition for picking up the still image.

When gain to be used in step S718 is Gain, a signal level in a pixel position (x, y) of the image before correction is in (x, y), and a signal level in the pixel position (x, y) of the image after correction is out (x, y), the following (Formula 6) and (Formula 7) are established.

[Equation 5]

out(x, y)=Gain×in(x, y) (Formula 6)

[Equation 6]

Gain=2^{(EVp-EV)} (Formula 7)

In Formula 7, EVp is an exposure value for generation of the panoramic image, and EV is an exposure value calculated for the still image set in step S710. EVp can be derived by calculation in step S704 and may be provided as a preliminary evaluation value. In this case, even without the image for the panoramic image, the image pickup condition for the still image can be obtained, and the image for the still image can be picked up.

Through the processing, luminance of the image picked up as the still image is adjusted to an equivalent level to luminance of the image picked up for generation of the panoramic image. Consequently, even when the image picked up for normal still image pickup is used for generation of the panoramic image, the panoramic image can be generated without unnaturalness.

In step S707, the image processing unit 106 performs development processing to the image picked up in step S706 or S715.

In step S708, the control unit 101 determines whether or not an end instruction is provided. In a case in which an end instruction is provided, image pickup for generation of a panoramic image is ended, and the procedure moves to step S709. In a case in which no end instruction is provided, the procedure returns to step S702.

In step S709, unlike the first embodiment, combining processing is performed with use of not only the image picked up for generation of the panoramic image and undergone the development processing but also the image picked up as the still image. When the combining processing is performed with use of only the image picked up for generation of the panoramic image, the density of the image only at a position of the image picked up as the still image is lowered. However, in the present embodiment, since the image picked up as the still image is used for the combining processing as well, the density of the image is secured.

The aforementioned steps S711 and S712 will be described. In the present embodiment, since the image picked up as the still image is also used for generation of the panoramic image, the gain processing needs to be performed in step S718 to correct the luminance value of the image picked up as the still image to be equivalent to the luminance value of the image for generation of the panoramic image. In a case in which the image pickup condition when the still image is picked up is a condition in which the brightness is higher than that in the image pickup condition when the image for generation of the panoramic image is picked up, a gain decrease will be performed in the gain processing in step S718. In a case in which the image picked up as the still image includes a saturated part, an image signal of the saturated part will be corrected into a lower value than an upper limit value of the image signal although the image signal of the saturated part should not be corrected.

To avoid this, in step S711, the control unit 101 determines whether or not the image pickup condition when the still image is picked up is a condition in which the brightness is higher than that in the image pickup condition when the image for generation of the panoramic image is picked up, and if so, the control unit 101 determines that the exposure value needs to be adjusted.

Also, to prevent the gain decrease from being performed in step S718, the exposure value is adjusted in step S712 in accordance with the function illustrated in FIG. 8.

The function illustrated in FIG. 8 means that, in a case in which the exposure value calculated in step S710 is further on the overexposure side than the exposure value at the time of picking up the panoramic image, the calculated exposure value is adjusted to be equal to the exposure value at the time of picking up the panoramic image. However, the function illustrated in FIG. 8 is illustrative only for adjustment of the exposure value in step S712, and the slope and the saturation value of the functional graph illustrated in FIG. 8 can be changed by user setting.

As described above, according to the second embodiment, since the same image pickup operation as that in the first embodiment is performed, and the still image is also used for generation of the panoramic image, more images that can be used for generation of the panoramic image can be picked up.

### Other Embodiments

Description has been provided, considering application of the above embodiments to a digital camera. However, application of the above embodiments is not only to the digital camera. For example, the above embodiments can be applied to a mobile terminal in which an image pickup device is built, such as a network camera that can pick up an image.

One or more embodiments of the present disclosure can be achieved by processing in which a program that fulfills one or more functions of the above embodiments is supplied to a system or an apparatus via a network or a storage medium, and in which one or more processors in a computer of the system or the apparatus reads out and operates the program. One or more embodiments of the present disclosure can also be achieved by a circuit that fulfills one or more functions (for example, ASIC).

According to the above-described processing, the user can pick up an image for a panoramic image and a still image having appropriate exposure with use of a digital camera. By setting a more appropriate exposure value at the time of picking up the still image, an image that is easy for the user to observe can be provided.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-106642, filed May 27, 2016, which is hereby incorporated by reference herein in its entirety.

What is claimed is:

1. An image pickup apparatus, comprising:
an image pickup device configured to pick up an image; and
a control circuit configured to set an image pickup condition when the image pickup device picks up the image and to perform combining processing for combining a plurality of images picked up by the image pickup device to generate a combined image,
wherein,
while the image pickup device picks up a plurality of images categorized as a first image group, the image pickup device picks up a plurality of images categorized as a second image group, which is different from the first image group, plural times,
the control circuit sets a changeable image pickup condition where the image pickup device picks up the images of the first image group and the second image group,
a range of the changeable image pickup condition where the image pickup device picks up the images of the first image group is narrower than a range of the changeable image pickup condition where the pickup device picks up the images of the second image group, and
the control circuit performs the combining processing, using the plurality of images of the first image group and not using the plurality of images of the second image group.

2. The image pickup apparatus according to claim 1,
wherein, the image pickup device picks up the images of the first image group, under a common image pickup condition.

3. The image pickup apparatus according to claim 1,
wherein the control circuit performs the combining processing after performing alignment processing to the images used in the combining processing.

4. The image pickup apparatus according to claim 1,
wherein the number of the plurality of images of the first image group is larger than the number of the plurality of images of the second image group.

5. The image pickup apparatus according to claim 1,
wherein the image pickup condition includes an exposure value.

6. The image pickup apparatus according to claim 5,
wherein the exposure value is determined by an aperture value, image pickup time, and a sensitivity value.

7. The image pickup apparatus according to claim 5,
wherein, each time each of the plurality of images of the second image group is to be picked up, the control circuit calculates the exposure value based on an image picked up by the image pickup device previously and sets an image pickup condition for each of the images of the second image group based on the exposure value.

8. The image pickup apparatus according to claim 5,
wherein, when the control circuit picks up the plurality of images of the first image group, the control circuit calculates the exposure value based on the image picked up by the image pickup device previously and sets an image pickup condition for the plurality of images of the first image group based on the exposure value.

9. The image pickup apparatus according to claim 8,
wherein, before a first image in the first image group is picked up, the control circuit sets a common image pickup condition to the plurality of images of the first image group.

10. The image pickup apparatus according to claim 1,
wherein the image pickup device picks up the images of the second image group in a case of satisfying a predetermined condition, and the predetermined condition includes at least any of a moving distance, a rotating angle, a pickup count, and a pickup period of the image pickup apparatus.

11. The image pickup apparatus according to claim 1,
wherein the control circuit cuts out and combines parts of the images, which are picked up by the image pickup device, in the combining processing.

12. The image pickup apparatus according to claim 1, further comprising:
a storage circuit configured to store the combined image and the plurality of images of the second image group.

13. The image pickup apparatus according to claim 12,
wherein the storage circuit stores the plurality of images of the second image group as RAW images.

14. An image pickup apparatus, comprising:
an image pickup device configured to pick up an image; and
a control circuit configured to set an image pickup condition when the image pickup device picks up the image and to perform combining processing for combining a plurality of images picked up by the image pickup device to generate a combined image,
wherein,
while the image pickup device is swung and picks up a plurality of images categorized as a first image group, the image pickup device picks up a plurality of images categorized as a second image group, which is different from the first image group, plural times,
the control circuit sets a changeable image pickup condition where the image pickup device picks up the images of the first image group and the second image group,
a range of the changeable image pickup condition where the image pickup device picks up the images of the first image group is narrower than a range of the changeable image pickup condition where the pickup device picks up the images of the second image group, and
the control circuit performs the combining processing, using at least the plurality of images of the first image group.

15. The image pickup apparatus according to claim 14,
wherein the image pickup condition includes an exposure value.

16. The image pickup apparatus according to claim 15, further comprising:
an adjusting circuit configured to adjust a luminance value for at least some images of the second image group based on the image pickup condition set for the plurality of images of the first image group,
wherein the control circuit performs the combining processing, using the plurality of images of the second image group as well as the plurality of images of the first image group.

17. The image pickup apparatus according to claim 16,
wherein the adjusting circuit adjusts the luminance value by performing gain processing.

18. An image pickup method, comprising:
an image pickup step for picking up an image; and
a control step for setting an image pickup condition when the image is picked up in the image pickup step and performing combining processing for combining a plurality of images picked up in the image pickup step to generate a combined image,
wherein,
in the image pickup step, while a plurality of images categorized as a first image group are picked up, a plurality of images categorized as a second image group, which is different from the first image group, are picked up plural times,
in the control step, a changeable image pickup condition is set for picking up the images of the first image group and the second image group,
a range of the changeable image pickup condition of picking up the images of the first image group is narrower than a range of the changeable image pickup condition of picking up the images of the second image group, and
the combining processing is performed, using the plurality of images of the first image group and not using the plurality of images of the second image group.

19. A non-transitory computer-readable storage medium storing at least one program to cause an image pickup apparatus to perform an image pickup method, the image pickup method comprising:
an image pickup step for picking up an image; and
a control step for setting an image pickup condition when the image is picked up in the image pickup step and performing combining processing for combining a plurality of images picked up in the image pickup step to generate a combined image,
wherein,
in the image pickup step, while a plurality of images categorized as a first image group are picked up, a plurality of images categorized as a second image group, which is different from the first image group, are picked up plural times,
in the control step, a changeable image pickup condition is set for picking up the images of the first image group and the second image group,
a range of the changeable image pickup condition of picking up the images of the first image group is narrower than a range of the changeable image pickup condition of picking up the images of the second image group, and
the combining processing is performed, using the plurality of images of the first image group and not using the plurality of images of the second image group.
